(19) United States
(12) Patent Application Publication
(10) Pub. No.: US 2013/0097548 A1
(43) Pub. Date: Apr. 18, 2013

(54) Virtual Keyboard, Input Method, and Associated Storage Medium

(71) Applicants: Fan Yang, Beijing (CN); Shijun Yuan, Beijing (CN)

(72) Inventors: Fan Yang, Beijing (CN); Shijun Yuan, Beijing (CN)

(73) Assignee: Nokia Corporation, Espoo (FI)

(21) Appl. No.: 13/575,924

(22) PCT Filed: Jan. 29, 2010
(86) PCT No.: PCT/CN2010/070413

§ 371 Date: Jul. 27, 2012

(51) Int. Cl. G06F 3/0488

(52) U.S. Cl. CPC G06F 3/04886
USPC 715/773

(57) ABSTRACT

Apparatus, a method and a computer program are provided. The apparatus comprises, at least one processor; and at least one memory including computer program code; the at least one memory and the computer program on a key code configured to, with the at least one processor, cause the apparatus at least to perform: receiving pressing of a key on a virtual keyboard; determining, based on a predetermined rule, whether the pressed key in a main input mode can be mapped to an auxiliary input mode; and displaying one or more keys for the auxiliary input mode in an expandable region of the virtual keyboard if the key can be mapped to the auxiliary input mode.

### TECHNICAL FIELD

The present invention generally relates to an input method, and more particularly, relates to a virtual keyboard, a device using the virtual keyboard, an input method, and associated storage medium.

### BACKGROUND

With the development of touch screen technology, touch screen has become an important input device in electronic devices, in particular small-type electronic devices (for example, a mobile phone, a personal digital assistant PDA, etc.). In order to input character information to an electronic device, the most common way is to input character information with the virtual keyboard displayed on a touch screen.

FIG. 1 is a schematic diagram of a touch screen of a typical electronic device which inputs Chinese characters by pinyin. In FIG. 1, reference sign 100 represents a touch screen; reference sign 101 represents an input display region; reference sign 102 represents a candidate display region; reference sign 103 represents a virtual keyboard region; and reference sign 104 represents a current input window.

As shown in FIG. 1, when a Chinese character is input by pinyin through the touch screen 100, the pinyin letter corresponding to the key pressed by a user is displayed on the current input window 104, and one or more candidate Chinese characters corresponding to the pinyin letter in the current input window 104 are prompted in the candidate display region 102. The user can directly select a Chinese character as prompted in the candidate display region 102, so as to input the desired Chinese character. The selected Chinese character is displayed in the current input window 104 to replace the inputted pinyin.

Typically, after the user typing some characters in a current input mode, there are several cases that may follow: he may continue to input; he may select a relevant candidate; he may input some symbols; he may want to use some application functions, such as send, save, and close, etc.

However, due to the limitation of the number of keys on a virtual keyboard, the number of necessary characters that can be displayed is also limited. In other words, usually there are not enough keys to display candidate characters, symbols, and function keys at the same time. Accordingly, the user has to leave the current virtual keyboard to find the desired character or function key in other paths.

For example, if the user wants to input a character of other input mode, for example, various kinds of punctuations under a symbol input mode, or smiley under the smiley input mode, he has to switch to a separate symbol input mode or smiley input mode for input.

Currently, there are two switching manners for input mode, one being to provide a dedicated input mode switch key on the virtual keyboard. According to this switching manner, if the current input mode of the user is Chinese or English input mode, he needs three steps when he inputs symbols. Firstly, the user presses the input mode switch key to thereby switch to for example a symbol input mode. In the symbol input mode, the virtual keyboard region displays various symbols for the user to select and input. Next, the user selects a symbol for input. Finally, the user re-presses the input mode switch key or other exit key, and etc, to return to the original Chinese or English input mode, such that other actions can be continued.

The other switching manner is to switch to other input characters in combination of the shift key. For example, other characters are also displayed above some character keys. The characters displayed above will be input by pressing down the shift key first and then the character keys, thereby inputting the character displayed above. However, due to limitation of the number of the keys on a keyboard, other characters that can be added are also limited. However, if the user wants to return to the current input mode to continue inputting, he needs further pressing the shift key.

From the above existing input methods, if the user wants to input a character or command in other input mode different from the current input mode, the user must leave the current input mode, which interrupts the user's inputting process and decreases the inputting efficiency.

### SUMMARY

An objective of the present invention is to provide a virtual keyboard, a device using the virtual keyboard, an input method, and associated storage medium, and therefore a character or function command in other input mode is promptly input in the current input mode without interrupting the user's inputting.

According to an aspect of the present invention, there is provided an apparatus, comprising, at least one processor; and at least one memory including computer program code; the at least one memory and the computer program code configured to, with the at least one processor, cause the apparatus at least to perform: receiving pressing of a key on a virtual keyboard; determining, based on a predetermined rule, whether the pressed key in a main input mode can be mapped to an auxiliary input mode; and displaying one or more keys for the auxiliary input mode in an expandable region of the virtual keyboard if the key can be mapped to the auxiliary input mode.

According to another aspect of the present invention, there is provided an electronic device, the electronic device having a touch screen, wherein the electronic device is configured with a virtual keyboard according to an embodiment of the present invention.

According to a further aspect of the present invention, there is provided an input method for a virtual keyboard, wherein the virtual keyboard is divided into a plurality of input modes, the method including: receiving pressing on a key on the virtual keyboard; determining, based on a predetermined rule, whether the key in a main input mode can be mapped to an auxiliary input mode; and if it can be mapped to the auxiliary input mode, one or more keys for the auxiliary input mode are displayed in an expandable region of the virtual keyboard.

According to a still further aspect of the present invention, there is provided an input apparatus for a virtual keyboard, wherein the virtual keyboard is divided into a plurality of input modes, the input apparatus including: receiving means for receiving pressing on a key on the virtual keyboard; determining means for determining, based on a predetermined rule, whether the key in a main input mode can be mapped to an auxiliary input mode; and displaying means for displaying one or more keys for the auxiliary input mode in an expandable region of the virtual keyboard if it can be mapped to the auxiliary input mode.

According to a yet further aspect of the present invention, there is provided a storage medium comprising a computer-readable program, wherein when the computer-readable program is executed by a processor, it enables the processor to implement the input method of the virtual keyboard according to an embodiment of the present invention.

According to the virtual keyboard, the device using the virtual keyboard, the input method, and associated storage medium of the present invention, since more input modes are mapped for some characters keys, available characters and/or commands of the virtual keyboard in the current input mode are potentially increased. When these character keys are pressed, the keys of the mapped input mode can be displayed in the expandable region of the virtual keyboard without increasing the screen display space occupied by the virtual keyboard.

Besides, according to an embodiment of the present invention, the user can access more characters or commands without leaving the current input mode, which helps the user input smoothly. Further, according to an embodiment of the present invention, steps of inputting characters or commands such as symbols and phrases in the auxiliary input mode are decreased in the main input mode. Finally, the embodiments of the present invention improve user experience and add more fun.

The above and other objectives, features and advantages will become more obvious when reading the detailed description of the exemplary embodiments as described hereinafter with reference to the accompanying drawings.

### BRIEF DESCRIPTION OF THE DRAWINGS

Hereinafter, the present disclosure provides details of the preferred embodiments with reference to the accompanying drawings, wherein:

FIG. 1 is a schematic diagram of a touch screen of a typical electronic device which inputs Chinese characters by pinyin;

FIG. 2 is a schematic diagram of a touch screen of an electronic device according to a preferred embodiment of the present invention;

FIG. 3 is a schematic diagram of a touch screen of an electronic device according to another preferred embodiment of the present invention;

FIG. 4 is a schematic diagram of a touch screen of an electronic device according to a further preferred embodiment of the present invention;

FIG. 5 is a schematic diagram of a touch screen of an electronic device according to a still further preferred embodiment of the present invention;

FIG. 6 is a flow chart of a virtual keyboard input method according to a preferred embodiment of the present invention;

FIG. 7 is a schematic diagram of the structure of an electronic device according to a preferred embodiment of the present invention;

FIG. 8 is a structural diagram of a virtual keyboard input apparatus according to a preferred embodiment of the present invention;

FIG. 9 shows a portable device in which one illustrative embodiment of the present invention can be implemented;

FIG. 10 shows a configuration schematic of the portable device as shown FIG. 9.

Like reference numerals designate the same, similar, or corresponding features or functions throughout the drawings.

### DETAILED DESCRIPTION

Now, the preferred embodiments of the present invention will be described in detail.

In the description of the present invention, in order to accommodate the characters and command functions required for inputting text, it is very typical to divide all the necessary characters and command functions into a plurality of groups. Each group may be regarded as a mode in a virtual keyboard, which is here called “input mode”. Typical input modes include: English input mode, symbol input mode, number input mode, smiley input mode, operation command input mode, and various kinds of simplified and traditional Chinese input modes. Chinese input modes may be pinyin/zhuyin/five-stroke input methods, etc. The “main input mode” refers to the current input mode. The “auxiliary input mode” is other input mode different from the current input mode. “Candidate” refers to candidate characters/commands to be displayed according to the user's input content.

In a preferred embodiment of the present invention, a virtual keyboard may be divided into a plurality of input modes. According to a predetermined rule, character keys on the virtual keyboard are additionally mapped with an auxiliary input mode other than the main input mode. When such character keys are pressed, one or more keys of the mapped auxiliary input mode may be displayed in an expandable region of the virtual keyboard.

Whether a key in one input mode can be mapped to keys in other mode and the keys mapped to other input mode are defined by a predetermined rule. A predetermined rule may include for example:

In the Chinese pinyin input mode, if “i” key is taped as the start character, it can be mapped to keys such as “,”, “.”. “?” in the symbol input mode;

In the Chinese pinyin input mode, if “u” key is taped as the start character, it can be mapped to various kinds of smiley symbol keys in the smiley input mode;

In the Chinese pinyin input mode, if “v” key is taped as the start character, it can be mapped to keys such as “ [symbol] ”, “ [symbol] ”. “ [symbol] ”, “ [symbol] ” etc. in the Chinese number input mode;

In the English input mode, “a” key is mapped to keys such as á, â, ã, ä, \dot{a}, æ in a variant input mode;

In the English input mode, “s” key is mapped to keys such as “Send” and “Save and close” in a command input mode;

A predetermined rule may be set based on use habit or use frequency as well as the correlation between keys in each input mode. A user can also modify the predetermined rule based on his/her own preferences.

In one embodiment, the virtual keyboard may be configured to receive the pressing on a key on the virtual keyboard. Next, based on a predetermined rule, whether the pressed key in a main input mode can be mapped to an auxiliary input mode is determined.

If it can be mapped to an auxiliary input mode, the keys in the auxiliary input mode are displayed in an expandable region of the virtual keyboard.

In another preferred embodiment, the virtual keyboard may be configured to determine whether a key in the main input mode can be mapped to the auxiliary input mode based on a predetermined rule when entering into the main input mode. If a key in the main input mode can be mapped to the auxiliary input mode, the key is mapped to the auxiliary input mode. In a still further embodiment, a mark is displayed on the mapped key. For example, distinguishing can be made on at least one of color, font, and size so as to facilitate user identification and improve input efficiency. Alternatively, a corresponding icon may be displayed in the right upper corner of the current character key, so as to prompt the user the auxiliary input mode to which the key is additionally mapped.

According to one preferred embodiment, if the key of the main input mode is not used under some circumstances, the key can be mapped with the auxiliary input mode. For example, in the Chinese pinyin input mode, no candidate items will be extracted for such pinyins starting with some letters (for example, “i”, “u”, and “v”), thus the keys for these letters can be expanded to map the auxiliary input mode.

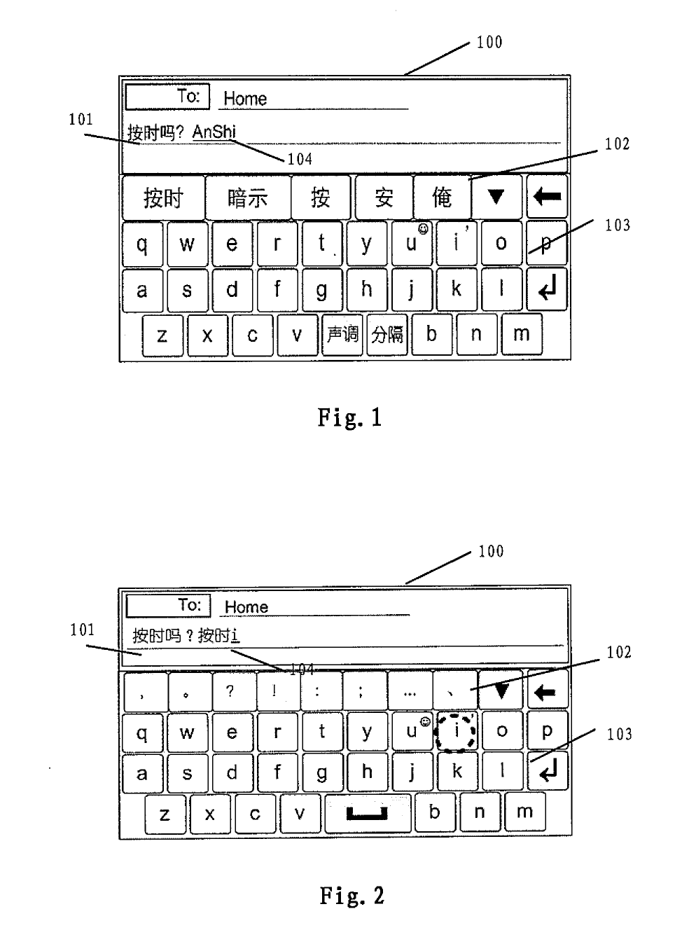

FIG. 2 is a schematic diagram of a touch screen of an electronic device according to a preferred embodiment of the present invention; The same reference numbers as in FIG. 1 indicate the same members as in FIG. 2, and the descriptions thereof is thus omitted.

In the preferred embodiment as shown in FIG. 2, the virtual keyboard region 103 comprises a plurality of keys, wherein at least one key is additionally mapped with an auxiliary input mode different from the main input mode. The main input mode as shown in FIG. 2 is a Chinese pinyin input mode, where “i” key is additionally mapped with the symbol input mode and “u” key is additionally mapped with the smiley input mode.

When inputting starts with “i”, an inline letter “i” is displayed in the current input window 104. At the same time, keys for symbol input mode, for example, “,”, “.”, and “?” and etc, can be displayed in the candidate display region 102 of the virtual keyboard. The candidate display region 102 is expandable. If the desired symbol is not displayed in the candidate region 102, the user can turn screens to the candidate region 102, so as to look up more candidate symbols. The user may further select a symbol from the candidate region, and the selected symbol replaces the inline letter “i” in the current input window 104 and is displayed in the current input window 104.

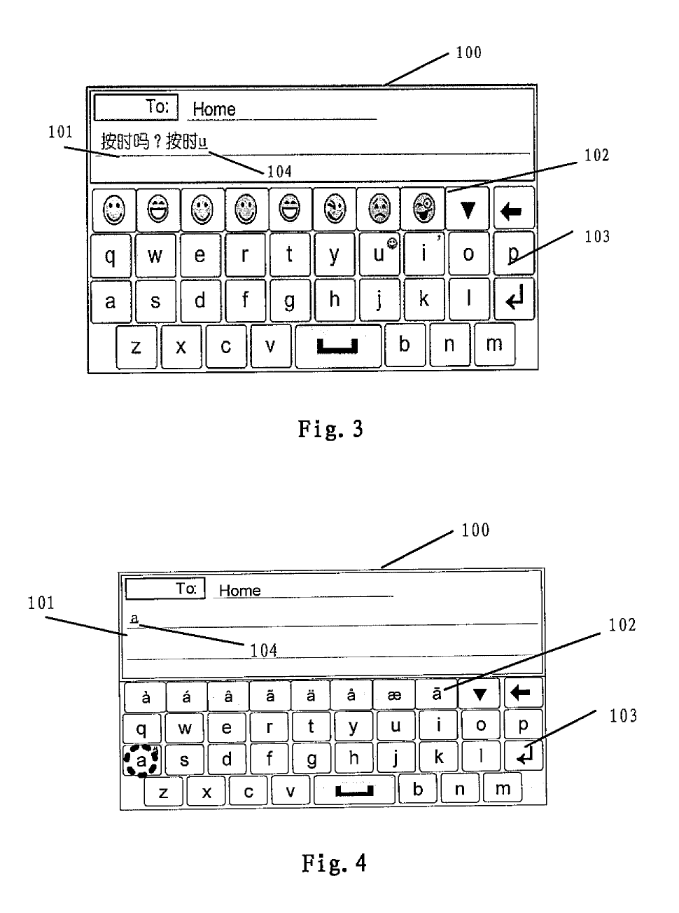

Similarly, FIG. 3 shows a schematic diagram of the touch screen when inputting starts with “u” in the preferred embodiment of FIG. 2. When inputting starts with “u”, an inline letter “u” is displayed in the current input window 104. At the same time, keys for smiley input mode are shown in the candidate display region 102 of the virtual keyboard, for example various smiley symbols as shown in FIG. 3. The user may further select a symbol from the candidate region, and the selected symbol replaces the inline letter “u” in the current input window 104 and is displayed in the current input window 104.

In the above preferred embodiments, if “i”, “u”, and “v” are input in a pinyin mode as syllable rhymes (“Yunmu”), they are displayed in a routine manner. For example, as shown in FIG. 1, Chinese characters available for selection are displayed in the candidate region.

In another preferred embodiment, if a key in the main input mode is similar to a key in the auxiliary input mode, for example similar in writing or pronunciation (accented characters), or a variant thereof, the key may be mapped to the auxiliary input mode. For example, In the English input mode, some letters have corresponding variants. For example, variants for letter á, â, ã, ä, \dot{a}and æ, etc., and variants related to letter “e” are è, é, ê, ë, and ē, etc. Thus, keys for these letters can be expanded to map the auxiliary input mode.

FIG. 4 is a schematic diagram of a touch screen of an electronic device according to a preferred embodiment of the present invention;

In the preferred embodiment as shown in FIG. 4, the virtual keyboard region 103 comprises a plurality of keys, wherein at least one key is additionally mapped with an auxiliary input mode different from the main input mode. The main input mode as shown in FIG. 4 is an English input mode, where key “a” is additionally mapped with its variant input mode.

Usually, no candidate items are extracted in the English input mode. Thus, letter keys can be expanded to map the auxiliary input mode. When a letter key is pressed, relevant variants may be displayed in a candidate region as an expandable region for users to select and input.

For example, when a user presses “a” key, an inline letter “a” is displayed in the current display window 104. At the same rime, variant input keys related to letter a are displayed in the candidate display region 102 of the virtual keyboard, for example á, â, ã, ä, \dot{a}, and æ, etc. The candidate display region 102 is expandable. If the desired symbol is not displayed in the candidate region 102, the user can turn screens to the candidate region 102, so as to look up more candidate symbols. The user may further select a symbol from the candidate region, and the selected symbol replaces the inline letter “a” in the current input window 104 and is displayed in the current input window 104.

In a still another preferred embodiment, if a key in the main input mode is associated with some command functions, the key may be mapped to a command input mode. For example, Send and Save and close commands start with “s”; New command starts with “n”. Thus, in the English input mode, the letter key “s” may be mapped as a command input mode with “Send” and “Save and close” commands, while the letter key “n” may be mapped as a command input mode with “New” command. The skilled in the art may appreciate, though the initial letter of a command is associated with a letter key as shown in the example, a command can also be associated with a letter key in other manner. For example, Exit command may be typically associated with letter key “x”. In a preferred embodiment, commonly-used abbreviations in the computer field are used for association so as to facilitate a user to memorize and use.

FIG. 5 is a schematic diagram of a touch screen of an electronic device according to a preferred embodiment of the present invention;

In the preferred embodiment as shown in FIG. 5, the virtual keyboard region 103 comprises a plurality of keys, wherein at least one key is additionally mapped with an auxiliary input mode different from the main input mode. The main input mode as shown in FIG. 5 is an English input mode, where key “s” is additionally mapped with command input modes associated with “s”.

Usually, no candidate items are extracted in an English input mode. Thus, the keys of auxiliary input mode to which letter keys are additionally mapped can be displayed in a candidate region as an expandable region, for users to select and input.

As shown in FIG. 5, when a user presses “s” key, an inline letter “s” is displayed in the current display window 104. At the same time, command input keys associated with letter s are displayed in the candidate display region 102 of the virtual keyboard, for example, Send, Save and close, and etc. Similarly, the candidate display region 102 is expandable. If there are too many associated command input keys and it is impossible for displaying all in the candidate region 102, then the user can turn screens to the candidate region 102 to look up more candidate commands. In the example as shown in FIG. 5, since there are only two associated command input keys, the current candidate region is sufficient to accommodate the two command input keys. Further, the user may select a required command from the candidate region to thereby perform corresponding operation.

In a yet further embodiment, the keys of the auxiliary input mode as shown in the expandable region can be varied based on at least one of the following: use frequency, current input content, application where the current input is located. For example, in a preferred embodiment, if the user inputs in an email application, the variants associated with the letter key “a” may further comprise @, thereby facilitating the user to input an email address. If the user inputs in a web browser application, the variants associated with the letter key “h” may comprise http://, and https://, etc. It should be appreciated that the skilled in the art can also design other input modes which facilitate improvement of user input efficiency.

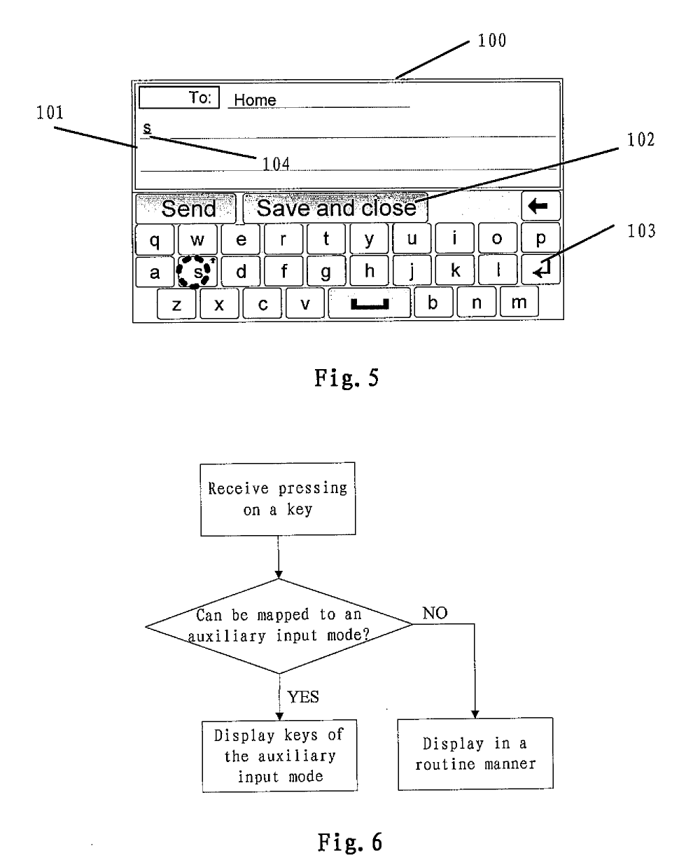

FIG. 6 is a flow chart of input method of a virtual keyboard according to a preferred embodiment of the present invention;

At step S601, pressing of a key on a virtual keyboard is received.

At step S602, based on a predetermined rule, whether the pressed key in a main input mode can be mapped to an auxiliary input mode is determined. If the determination result is “yes”, the process proceeds to step S603. Otherwise, the process goes to step S604 to perform input in a routine manner.

At step S603, the keys in the auxiliary input mode mapped to the pressed key are displayed in an expandable region of a virtual keyboard.

Next, as known to the skilled in the art, further input of the user is waited for. Further input may either be to select a key displayed in the expandable region, or to continue pressing other key in the virtual keyboard. If a letter key displayed in the expandable region is selected, the selected character is displayed in the current input window. If a command key displayed in the expandable region, corresponding action is performed based on the selected command. If the user continues to press other key in the virtual keyboard, the process may return to the step S601 to continue receiving.

In an alternative embodiment, the virtual keyboard may be pre-configured before receiving pressing over the key. For example, when the virtual keyboard enters a main input mode, firstly, whether a key in the main input mode can be mapped to an auxiliary input mode is determined based on a predetermined rule. If a key in the main input mode can be mapped to the auxiliary input mode, the key is mapped to the auxiliary input mode. In a still further embodiment, a mark is displayed on the mapped key. For example, distinguishing can be made on at least one of color, font, and size so as to facilitate user identification and improve input efficiency. Alternatively, a corresponding icon may be displayed in the right upper corner of the current character key, so as to prompt the user the auxiliary input mode to which the key is additionally mapped.

According to an embodiment of the present invention, if the candidate region of a letter key is blank in the main input mode, i.e. there are no available candidate items, the space in the candidate region will be fully utilized to display keys in an auxiliary input mode. Based on a predetermined rule, character keys are additionally mapped to the auxiliary input mode. Based on different conditions, specific predetermined rules may be various.

According to one preferred embodiment, the predetermined rule may be: if the key of the main input mode is unavailable under some circumstances, the key can be mapped with the auxiliary input mode. For example, in the Chinese pinyin input mode, no candidate items will be extracted for such pinyin starting with some letters (for example, “i”, “u”, and “v”), thus the keys for these letters can be expanded to map the auxiliary input mode. For example, an auxiliary input mode may be a symbol input mode, smiley input mode, etc.

In another preferred embodiment, the predetermined rule may be: if a key in the main input mode is similar to a key in the auxiliary input mode, for example similar in writing or pronunciation (accented characters), or a variant thereof, the key may be mapped with the auxiliary input mode. For example, in the English input mode, some letters have corresponding variants. For example, variants for letter a are á, â, ã, ä, \dot{a}, and æ, etc., and variants related to letter e are è, é, ê, ë, and ē, etc. Thus, keys for these letters can be expanded to map the variant character input mode. Further, when these keys are pressed, associated variant characters are displayed in the candidate region of the virtual keyboard.

In a still another preferred embodiment, the predetermined rule may be: if a key in the main input mode is associated with some command functions, the key may be mapped with a command input mode. For example, Send and Save and close commands start with “s”; New command starts with “n”. Thus, in the English input mode, the letter key “s” may be mapped as a command input mode with “Send” and “Save and close” commands, while the letter key “n” may mapped as a command input mode with “New” command.

In a still further embodiment, the predetermined rule may further comprise one of the following conditions: use frequency, current input content, and application program where the current input is located. Based on these conditions, the keys for the auxiliary input mode to be displayed in the expandable region are determined.

In the embodiment of the present invention, there is provided an apparatus, comprising: at least one processor; and at least one memory including computer program code; the at least one memory and the computer program code configured to, with the at least one processor, cause the apparatus at least to perform: receiving pressing of a key on a virtual keyboard; determining, based on a predetermined rule, whether the pressed key in a main input mode can be mapped to an auxiliary input mode; and displaying one or more keys for the auxiliary input mode in an expandable region of the virtual keyboard if the key can be mapped to the auxiliary input mode.

The apparatus may, for example, be a chip or a chip-set. In alternative embodiments of the invention, the apparatus may comprise multiple processors.

The processor is configured to read from and write to the memory. The processor may also comprise an output interface via which data and/or commands are output by the processor and an input interface via which data and/or commands are input to the processor.

The memory may be implemented as one or more separate components, some or all of which may be integrated/removable and/or may provide permanent/semi-permanent/dynamic/cached storage.

The memory stores a computer program comprising computer program codes that control the operation of the apparatus when loaded into the processor. The computer program codes provide the logic and routines that enables the apparatus to perform the method illustrated in FIG. 6. The processor by reading the memory is able to load and execute the computer program codes.

The computer program may arrive at the apparatus via any suitable delivery mechanism. The delivery mechanism may be, for example, a tangible computer-readable storage medium, a computer program product, a memory device, a record medium such as a CD-ROM, DVD or Blue-Ray disc, or any article of manufacture that tangibly embodies the computer program. The delivery mechanism may be a signal configured to reliably transfer the computer program.

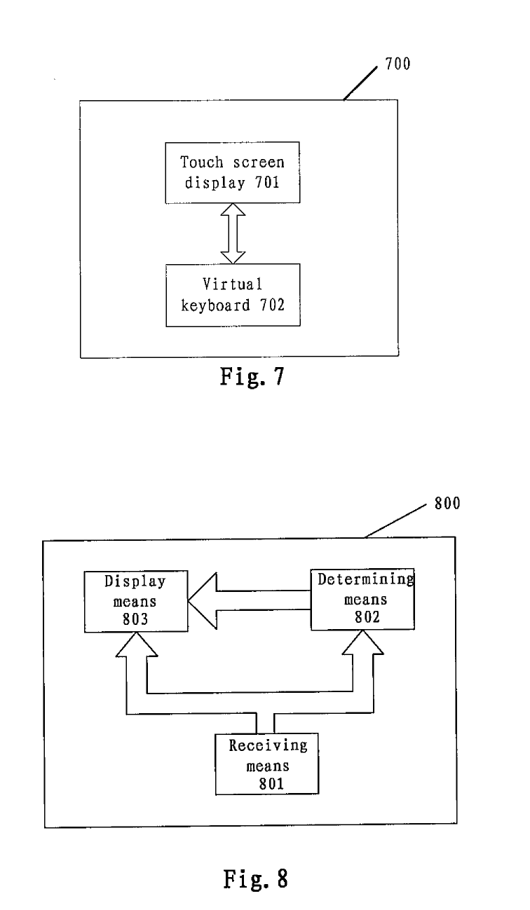

FIG. 7 is a schematic diagram of the structure of an electronic device according to a preferred embodiment of the present invention; wherein reference sign 700 represents an electronic device; reference sign 701 represents a touch screen display device; and reference sign 702 indicates a virtual keyboard.

As shown in FIG. 7, the virtual keyboard 702 may be divided into a plurality of input modes. According to a predetermined rule, character keys on the virtual keyboard are additionally mapped with an auxiliary input mode other than the main input mode. When the user presses the character key additionally mapped with the auxiliary input mode, one or more keys for the mapped auxiliary input mode may be displayed in an expandable region of the virtual keyboard.

FIG. 8 is a structural diagram of a virtual keyboard input apparatus according to a preferred embodiment of the present invention; Wherein reference sign 800 represents input apparatus of the virtual keyboard; reference sign 801 represents receiving means; reference sign 802 represents determining means; and reference sign 803 represents display means.

Receiving means 801 receives pressing of a key on a virtual keyboard. Determining means 802 determines, based on a predetermined rule, whether the pressed key in a main input mode can be mapped to an auxiliary input mode. If the determining result is “yes”, the key for the auxiliary input mode to be mapped to the pressed key is displayed in the expandable region of the virtual keyboard through a display means 803. Otherwise, the display means 803 displays in a normal way.

In an alternative embodiment, when the virtual keyboard enters in the main input mode, the determining means 802 determines whether a key in the main input mode can be mapped to the auxiliary input mode based on the a predetermined rule. If a key in the main input mode can be mapped to the auxiliary input mode, the key is mapped to the auxiliary input mode. In a still further embodiment, a mark is displayed on the mapped key through the display means 803, to thereby facilitate user identification and improve input efficiency. Alternatively, a corresponding icon may be displayed in the right upper corner of the current character key, so as to prompt the user the auxiliary input mode to which the key is additionally mapped.

FIG. 9 shows a portable device in which one illustrative embodiment of the present invention can be implemented.

The mobile terminal 900 comprises a speaker or earphone 902, a microphone 906, a touch display 903 and a set of keys 904 which may include virtual keys 904a, soft keys 904b, 904c and a joystick 905 or other type of navigational input device.

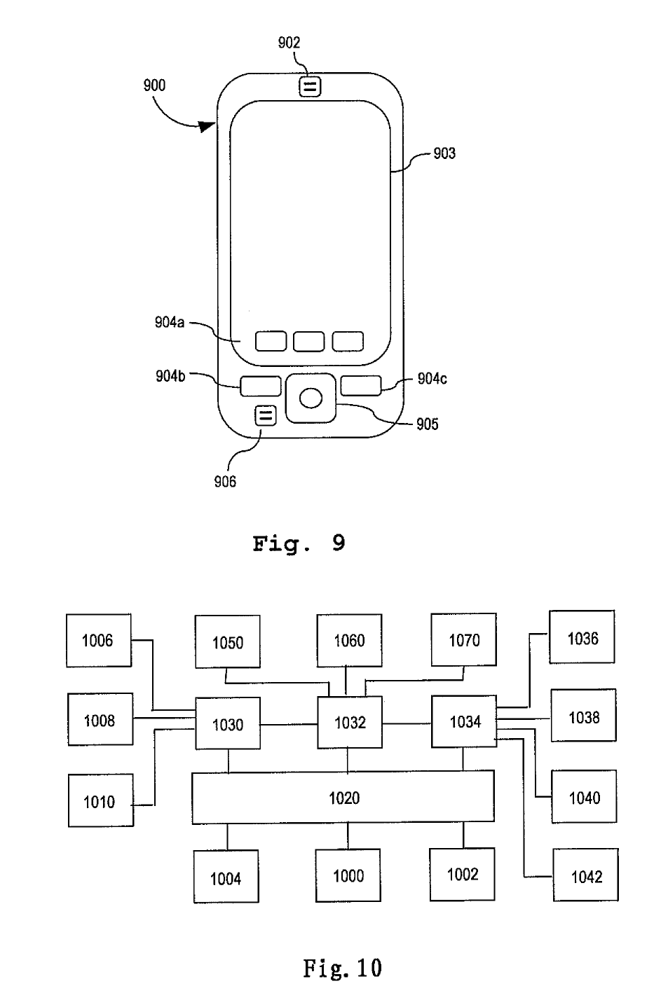

FIG. 10 shows a configuration schematic of the portable device as shown FIG. 9.

The internal component, software and protocol structure of the mobile terminal 900 will now be described with reference to FIG. 9. The mobile terminal has a controller 1000 which is responsible for the overall operation of the mobile terminal and may be implemented by any commercially available CPU (“Central Processing Unit”), DSP (“Digital Signal Processor”) or any other electronic programmable logic device. The controller 1000 has associated electronic memory 1002 such as RAM memory, ROM memory, EEPROM memory, flash memory, or any combination thereof. The memory 1002 is used for various purposes by the controller 1000, one of them being for storing data used by and program instructions for various software in the mobile terminal. The software includes a real-time operating system 1020, drivers for a man-machine interface (MMI) 1034, an application handler 1032 as well as various applications. The applications can include a message text editor 1050, a handwriting recognition (HWR) application 1060, as well as various other applications 1070, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application.

The MMI 1034 also includes one or more hardware controllers, which together with the MMI drivers cooperate with the first display 1036/903, and the keypad 1038/904 as well as various other I/O devices such as microphone, speaker, vibrator, ringtone generator, LED indicator, etc. As is commonly known, the user may operate the mobile terminal through the man-machine interface thus formed.

The software can also include various modules, protocol stacks, drivers, etc., which are commonly designated as 1030 and which provide communication services (such as transport, network and connectivity) for an RF interface 1006, and optionally a Bluetooth interface 1008 and/or an IrDA interface 1010 for local connectivity. The RF interface 1006 comprises an internal or external antenna as well as appropriate radio circuitry for establishing and maintaining a wireless link to a base station. As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc.

The mobile terminal also has a SIM card 1004 and an associated reader. As is commonly known, the SIM card 1004 comprises a processor as well as local work and data memory.

The present invention further provides a storage medium comprising a computer-readable program. When the computer-readable program is executed by the processor, it enables the processor to implement the input method of virtual keyboard according to the preferred embodiments of the present invention. The storage medium may be any tangible mediums, for example, floppy disk, CD-ROM, DVD, hard disk driver, and even network medium, etc.

The various aspects of what is described above can be used alone or in various combinations. The teaching of this application may be implemented by a combination of hardware and software, but can also be implemented in hardware or software. The teaching of this application can also be embodied as computer program product on a computer readable medium, which can be any material media, such as floppy disks, CD-ROMs, DVDs, hard drivers, even network media and etc.

The specification of the present invention has been presented for purposes of illustration and description, and is not intended to be exhaustive or limited to the invention in the form disclosed. Many modifications and variations will be apparent to those of ordinary skill in the art. It is understood by those skilled in the art that the method and means in the embodiments of the present invention can be implemented in software, hardware, firmware or a combination thereof.

Therefore, the embodiments were chosen and described in order to better explain the principles of the invention, the practical application, and to enable others of ordinary skill in the art to understand that all modifications and alterations made without departing from the spirit of the present invention fall into the protection scope of the present invention as defined in the appended claims.

1. An apparatus, comprising,
at least one processor;
and at least one memory including computer program code;
the at least one memory and the computer program code configured to, with the at least one processor, cause the apparatus at least to perform:
receiving pressing of a key on a virtual keyboard;
determining, based on a predetermined rule, whether the pressed key in a main input mode can be mapped to an auxiliary input mode; and
displaying one or more keys for the auxiliary input mode in an expandable region of the virtual keyboard if the key can be mapped to the auxiliary input mode.

2. The apparatus according to claim 1, wherein the apparatus is further caused to perform:
determining whether a key in the main input mode can be mapped to the auxiliary input mode based on a predetermined rule when the virtual keyboard enters the main input mode; and
displaying a mark on the key If the key in the main input mode can be mapped to the auxiliary input mode.

3. The apparatus according to claim 1, wherein the one or more keys of the auxiliary input mode as displayed in the expandable region is further determined based on the current input content.

4. The apparatus according to claim 1, wherein the predetermined rule comprises:
the key is mapped to the auxiliary input mode if the key is not used in the main input mode.

5. The apparatus according to claim 4, wherein the main input mode is a Chinese pinyin input mode, the auxiliary input mode is a symbol input mode or smiley input mode; the key is selected from “i”, “u”, and “v”.

6. The apparatus according to claim 1, wherein the predetermined rule comprises:
mapping the key to the auxiliary input mode if the key is similar to the auxiliary input mode.

7. The apparatus according to claim 6, wherein the main input mode is an English input mode, the auxiliary input mode is a variant character input mode; and when the key is pressed, variant characters associated with the key are displayed in the expandable region of the virtual keyboard.

8. The apparatus according to claim 1, wherein the predetermined rule comprises:
mapping the key to a command input mode if the key is associated with a key of the command input mode.

9. The apparatus according to claim 1, wherein the expandable region is expandable candidate region.

10. The apparatus according to claim 1, wherein the apparatus is an electronic device having a touch screen.

11. An input method for a virtual keyboard, wherein the virtual keyboard is divided into a plurality of input modes, the method comprising:
receiving pressing of a key on the virtual keyboard;
determining, based on a predetermined rule, whether the pressed key in a main input mode can be mapped to an auxiliary input mode; and
displaying one or more keys for the auxiliary input mode in an expandable region of the virtual keyboard if the key can be mapped to the auxiliary input mode.

12. An input method according to claim 11, wherein the method further comprises:
determining whether a key in the main input mode can be mapped to the auxiliary input mode based on a predetermined rule when entering the main input mode; and
displaying a mark on the key if the key in the main input mode can be mapped to the auxiliary input mode.

13. The input method according to claim 11, wherein the one or more keys of the auxiliary input mode as displayed in the expandable region is further determined based on the current input content.

14. The input method according to claim 11, wherein the predetermined rule comprises:
mapping the key to the auxiliary input mode if the key is not used in the main input mode.

15. The inputting method according to claim 14, wherein the main input mode is a Chinese pinyin input mode, the auxiliary input mode is a symbol input mode or smiley input mode; the key is selected from “i”, “u”, and “v”.

16. The input method according to claim 11, wherein the predetermined rule comprises:
mapping the key to the auxiliary input mode if the key is similar to the auxiliary input mode.

17. The input method according to claim 16, wherein the main input mode is an English input mode, the auxiliary input mode is a variant character input mode; and when the key is pressed, variant characters associated with the key are displayed in the expandable region of the virtual keyboard.

18. The input method according to claim 11, wherein the predetermined rule comprises:
mapping the key to a command input mode if the key is associated with a key of the command input mode.

19. The input method according to claim 11, wherein the expandable region is expandable candidate region.

20. (canceled)

21. A storage medium comprising a computer readable program, wherein when the computer readable program is executed by a processor, the processor is enabled to implement a method of claim 11.
